(19) United States
(12) Patent Application Publication
(10) Pub. No.: US 2026/0128690 A1
(43) Pub. Date: May 7, 2026

(54) METHOD FOR OPERATING AN INVERTER, INVERTER, AND ELECTRIC DRIVE SYSTEM

(71) Applicant: Robert Bosch GmbH, Stuttgart (DE)

(72) Inventors: Daniel Schweiker, Ludwigsburg (DE); Ekard Grossmann, Stuttgart (DE); Kay Hindorf, Ludwigsburg (DE); Mark Damson, Stuttgart (DE)

(21) Appl. No.: 19/116,506

(22) PCT Filed: Jul. 12, 2023
(86) PCT No.: PCT/EP2023/069294

§ 371 Date: Mar. 28, 2025

(30) Foreign Application Priority Data
Sep. 30, 2022 (DE) 10 2022 210 365.3

(51) Int. Cl. H02P 3/22

(52) U.S. Cl. CPC H02P 3/22

(57) ABSTRACT

The invention relates to a change from an active short circuit to the freewheel in an inverter of an electric drive system. For this purpose, a switching state corresponding to the switching state of the freewheel is temporarily set in a half-bridge of the inverter. The current curve in this half-bridge is then evaluated in order to check whether a change to the freewheel is permissible or not.

### BACKGROUND

The invention relates to a method for operating an inverter, in particular an inverter of an electric drive system. The present invention further relates to an inverter in which such a method is implemented, as well as an electric drive system having such an inverter.

Electric drive systems are used in numerous applications. Such electric drive systems are used, for example, in fully or at least semi-electrically driven vehicles. Electrical energy from a power source, for example the traction battery of an electric vehicle, can be converted by means of a inverter into an electric voltage, which is suitable for driving an electric machine. In addition, so-called safe operating states can also be set in the inverter, for example an active short-circuit in which the switching elements are controlled such that the terminals of the electric machine are short-circuited. Furthermore, a so-called freewheel can be provided, in which all switching elements in the half-bridges of the inverter are opened.

For example, publication DE 10 2014 222 256 A1 describes a method for switching an operating state of an electric machine from a freewheel into an active short circuit. Here, it is proposed that in a multi-phase electric machine, the individual phases are successively shifted into the corresponding switching states.

### SUMMARY

The present invention provides a method for operating an inverter, an inverter, and an electric drive system having the features of the disclosure. Further advantageous embodiments are the subject matter of the dependent claims.

The following is therefore provided:
A method for operating an inverter, in particular for operating an inverter for an electric drive system. The inverter comprises a plurality of half-bridges, each having two switching elements. The method comprises a step of setting an active short circuit in the inverter. In such an active short circuit, either the upper switching elements of all half-bridges or the lower switching elements of all half-bridges are closed. In this way, all phase terminals of an electrical machine connected to the inverter are electrically connected to one another, i.e. short-circuited. The method further comprises a step of opening the two switching elements in a first half-bridge of the inverter. In other words, in a first of the half-bridges of the inverter, a switching state corresponding to the switching state for a freewheel mode is set. Furthermore, the method comprises a step of determining an electrical parameter that characterizes a curve of a phase current in the direction of the first half-bridge, in which both switching elements are opened. Furthermore, the method comprises a step for setting a freewheel mode in the inverter, in which all switching elements of all half-bridges are opened when a curve of the phase current in the direction of the first half-bridge satisfies a predetermined change condition.

The determination of an electrical parameter that characterizes a curve of a phase current in the direction of the first half-bridge can be done for example using at least one current measuring device.

Of course, the phase current can take on positive and negative values, so that the phrase “phase current in the direction of the first half-bridge” is not to be construed as being restrictive in any way to the extent that only the current flowing in the direction of the first half-bridge is determined, but rather the phase current is of course also considered in the opposite direction, flowing away from the first half-bridge. Preferably, one or more current measuring devices are used in order to determine the electrical parameter, depending on the arrangement within the inverter, which allow the determination of a parameter that characterizes the curve of a phase current in the direction of the first half-bridge. Preferably, such a current measuring device can be arranged within a switching element of the half-bridge, which in particular detect currents through an intrinsic parallel-connected diode or a body diode of a switching element. Preferably, such a current measuring device is arranged in a supply line or discharge line of the current through a switching element of a half-bridge, preferably at the phase current terminal of a half-bridge.

The following is furthermore provided:
An inverter having a plurality of half-bridges and a control device. The plurality of half-bridges each comprise two switching elements. In particular, two semiconductor switching elements can be provided in each half-bridge, wherein a diode is provided parallel to each semiconductor switching element. The control device is designed so as to provide control signals for the switching elements in the plurality of half-bridges. Furthermore, the control device is designed so as to carry out a method according to the invention for operating the inverter.

Finally, the following is provided:
An electric drive system having an electric machine and an inverter according to the invention. The inverter is connected to the electric machine at an AC voltage terminal.
Furthermore, the inverter is designed so as to be connected to a DC power source at a DC voltage terminal.

An electric drive system typically comprises an electric power converter, for example an inverter which can convert a DC electric voltage supplied on the input side into an AC voltage in order to drive an electric machine. In this inverter, a so-called safe state can also be set under certain conditions. Such a safe state can be, for example, an active short circuit in which the switching elements of the inverter are controlled such that the phase terminals of an electric machine connected to the inverter are short-circuited. For example, all upper switching elements or all lower switching elements in the half-bridges of the inverter can be closed. For example, the switching elements connected to a positive tie point of a DC voltage terminal of the inverter can be referred to as upper switching elements, while the lower switching elements are connected to a negative tie point of the DC voltage terminal.

In addition, the so-called freewheel mode is known as a safe operating state. Here, all switching elements in the inverter are opened. If the electric machine connected to the inverter is in motion, an electric voltage can be induced in the phase coils of the electric machine. If the electric voltage from the electric machine exceeds the input voltage on the DC voltage side, an electric current from the electric machine can flow through the diodes provided parallel to the switching elements in the inverter to a battery connected to the DC voltage side of the inverter, or the like. Such a flow of current may not be desired, depending on the circumstances, and should therefore may need to be avoided or at least limited. Diodes provided parallel to the switching elements of the inverter can be understood as follows in terms of the present invention: separate electrical elements, integrated electrical elements, and/or an element that performs a function corresponding to a diode behavior due to the semiconductor structure of the switching element or a parasitic semiconductor structure of the switching element, in particular in the case of MOSFET.

It is therefore an idea of the present invention to switch from an active short circuit to a freewheel mode only when no, or at least no significant, current flow from the electric machine to the DC voltage side is to be expected. According to the present invention, it is initially provided that an inverter only sets a switching state corresponding to a freewheel mode in a first half-bridge. The curve of the electric current can then be evaluated in this half-bridge. According to this current curve, if no, or at least no significant, current flow from the electric machine to the DC voltage side is to be expected, the freewheel mode can then be set in all half-bridges.

In this way, by means of a temporary change from the switching state of the active short circuit to the switching state of a freewheel mode in only one half-bridge of an inverter, it can be easily checked whether, in a freewheel mode, the electric voltage supplied by a connected electric machine would set a current flow from the electric machine to the DC side of the inverter.

By contrast to conventional methods in which the criteria for a change between the active short circuit and freewheel is based only on estimates, for example a correlation between the rotational speed of the electric machine and expected induced electric voltage, the method according to the invention can be used in order to check the electric current flow being set under actual real conditions. Thus, a very accurate and reliable assessment of the operating conditions and any electric current flow being set from the electric machine to the DC voltage terminal can be carried out. Any necessary safety buffers, as are usually required for theoretical estimates, can be omitted.

According to one embodiment, in the method for operating the inverter, the switch from the active short circuit to the freewheel mode is made if the amount of phase current in the direction of the first half-bridge from a current zero pass does not exceed a specified threshold value. For example, if a switching state corresponding to a freewheel is already set shortly before a current zero pass in one of the half-bridges, it can be checked as a condition for the release of the freewheel mode whether the electric current in this half-bridge remains at zero after the zero pass or does not exceed at least a specified threshold value. If, in this half-bridge, the switching state for a freewheel is only set shortly after a current zero pass, it can be checked whether the electrical current in this half-bridge tends to increase or decrease more.

According to one embodiment, the switching element is opened in a half-bridge of the inverter when a curve of the phase current in the direction of the first half-bridge is at least approximately in the range of a zero pass. In this case, when a switching element is opened, no load, or at least only a very low load, must be switched. Preferably, the setting of the switching state corresponding to a freewheel can occur in the half-bridges at times when the electric current is exactly zero, or possibly as close to this time as possible.

According to one embodiment, to set the freewheel mode in the inverter, the switching elements remain open in the first half-bridge, in which both switching elements have previously been opened. Then, the switching elements in the further half-bridges of the inverter are opened for setting of the freewheel mode. In particular, the switching elements in the further half-bridges can be opened at times in which an electrical current in the respective half-bridges is as close as possible to a current zero pass. Thus, no load or only a small load must be switched when the switching elements are opened.

According to one embodiment, after determining the electrical parameter characterizing a curve of the phase current in the direction of the first half-bridge, the switching state for an active short-circuit is initially set again. For this purpose, the switching element in this half-bridge is closed, which was previously opened for checking the current flow. The curve of the phase current in the direction of the first half-bridge is then evaluated. Subsequently, after this evaluation, the freewheel mode in the inverter is set if the curve of the phase current in the direction of the first half-bridge satisfies the predetermined change condition. Because, in the meantime, the switching state of the active short-circuit has again been set in the inverter, this evaluation can also be carried out with a higher time requirement by a processing device with relatively low computer power.

According to one embodiment, the method comprises a step of determining a rotational speed of an electric machine connected to the inverter. The steps of opening the two switching elements, subsequently determining the electrical parameter, and changing to the freewheel mode may only be performed here if the determined rotational speed of the electric machine falls below a specified threshold value. Above this threshold value, an electrical voltage from the electric machine is expected that would almost certainly lead to a current flow through the inverter if a freewheel mode were to be set. Thus, at such high speeds of the electric machine, a check for the possible change to freewheel can be omitted.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. The figures show:

FIG. 1: a schematic representation of an electric drive system according to one embodiment;

FIG. 2: a current-time diagram for a current curve in an inverter according to one embodiment;

FIG. 3: a current-time diagram for a current curve in an inverter according to a further embodiment;

FIG. 4: a current-time diagram for a current curve in an inverter according to yet another embodiment; and

FIG. 5: a flow chart on which a method for controlling an inverter according to one embodiment is based.

### DETAILED DESCRIPTION

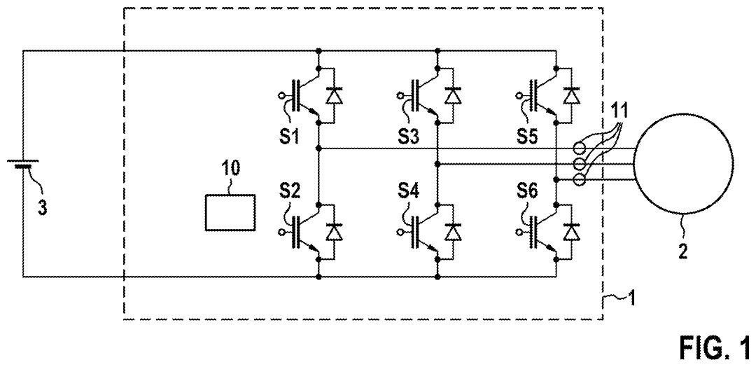

FIG. 1 shows a schematic representation of a block diagram for an electric drive system having an inverter 1 and an electric machine 2 according to one embodiment. For example, a DC voltage source 3, such as a battery, in particular a traction battery of an electric vehicle, can be connected to a DC voltage terminal of the inverter 1. An electric machine 2 can be connected to an AC voltage terminal of the inverter 1. The inverter 1 can convert the DC voltage supplied at the DC voltage terminal into an AC voltage that is suitable for controlling the electric machine 2. Optionally, the inverter 1 can also be designed so as to convert an AC voltage supplied by the electric machine 2 in a generator mode into a DC voltage that is suitable for recharging a battery connected to the DC voltage terminal.

A plurality of half-bridges, each having two switching elements S1 to S6, can be provided in the inverter 1. Each half-bridge comprises two serially connected switching elements S1 to S6, which are electrically connected to one another at a respective node. For each phase of an AC voltage to be supplied at an AC voltage terminal of the inverter 1, the inverter 1 can comprise a respective half-bridge of this kind. The nodes of the respective half-bridges, at which the two switching elements S1 to S6 are electrically connected, are connected to a tie point of the AC voltage terminal of the inverter 1 in each case.

The respective other terminals of the switching elements S1 to S6, i.e. those terminals of the switching elements S1 to S6 which are not connected to the AC voltage terminal of the inverter 1, are connected to a DC voltage terminal of the inverter 1. All switching elements S1, S3, S5, which are connected to a tie point for a first (for example positive) polarity of the DC voltage provided at the DC voltage terminal, are electrically connected to one another. Analogously, all switching elements S2, S4, S6, which are connected to a tie point for a second (for example negative) polarity of the DC voltage provided at the DC voltage terminal, are also electrically connected to one another. The switching elements S1, S3, S5 which are connected to the tie point of the DC voltage terminal for the first, positive polarity are also referred to as upper switching elements. Analogously, the switching elements S2, S4, S6 which are connected to the tie point of the DC voltage terminal for the second, negative polarity can be referred to as lower switching elements.

The switching elements S1 to S6 can be controlled by a control device 10. For this purpose, the control device 10 can provide a control signal for each of the switching elements S1 to S6, which is suitable for opening or closing the respective switching element S1 to S6.

In this way, for example, a desired AC voltage to control the electric machine 2 can be generated from the DC voltage supplied on the input side by means of pulse-width modulated control of the switching elements S1 to S6.

In addition, a so-called active short circuit can be set in the inverter 1. In such an active short circuit, the upper switching elements S1, S3, and S5 can be closed while the lower switching elements S2, S4, and S6 are opened. Alternatively, the upper switching elements S1, S3, and S5 can be opened while the lower switching elements S2, S4, and S6 are closed. In this way, all phase terminals of the electric machine 2 are electrically connected to one another, i.e., short-circuited.

In a further operating mode, a so-called freewheel can be set. All switching elements S1 to S6 are opened in the half-bridges of the inverter 1. If the electric machine 2 is in motion, an electric voltage can be induced in the phase coils of the electric machine 2. If this electrical voltage applied by the electric machine 2 at the AC terminal of the inverter 1 is sufficiently high, an electrical current can flow to the DC terminal of the inverter 1 through diodes arranged parallel to the switching elements S1 to S6. Such an electrical current during the freewheel mode can be limited or completely prevented.

If an active short-circuit is to be switched into a freewheel mode, it must therefore be checked before such a change whether a current flow from the electric machine 2 at the AC voltage terminal of the inverter 1 to the DC voltage terminal of the inverter 1 may be expected. For this purpose, a switching state can be set by the control device 10 in a first of the half-bridges of the inverter 1, in which both switching elements of a first half-bridge, S1+S2, S3+S4 or S5+S6, are opened. The switching elements of the remaining half-bridges initially remain in the switching state, which corresponds to the currently set active short circuit.

Preferably, this switching state, in which both switching elements are opened in the first half-bridge, is set at a point in time in which the electrical current through the previously closed switching element is at least approximately in the range of a zero pass. For example, the corresponding switch can be opened just before the electrical current through that switch reaches zero pass. Alternatively, the switch can also be opened exactly in the zero pass or shortly after the zero pass.

After this switching element has been opened, and thus a switching state corresponding to an active freewheel has been set in a half-bridge of the inverter 1, an electrical parameter that characterizes the curve of a phase current in the direction of the first half-bridge or characterizes, detects, or monitors the electrical current in this half-bridge can be detected. In particular, the electrical current that flows in the respective phase terminal, or through the diodes provided parallel to the opened switching elements during this switching state, can be monitored for this purpose. For example, the current curve can be detected by current sensors 11. At the control device 10, the current sensors 11 can provide a sensor signal corresponding to an electrical current at the phase terminals or the half-bridges.

If a significant current flow is detected, which may increase during the period of determination or monitoring, this can be deemed an indication that, when setting a full freewheel mode in the inverter 1, an electrical current will also flow from the electric machine 2 through the diodes arranged parallel to the switching elements S1 to S6. If such a current flow is not desired, in this case the active short circuit can continue to be maintained in the inverter 1. For this purpose, for example, the previously opened switching element can be closed again.

If, on the other hand, during the period described above in which both switching elements are opened in a half-bridge, no current flow is detected, or a current flow is detected that satisfies a previously specified condition, this can be deemed an indication that, in the event of a freewheel, the electrical voltage from the electric machine 2 applied at the AC voltage terminal of the inverter 1 is sufficiently low, so that no current flow from the AC voltage terminal to the DC voltage terminal will be set in the inverter 1.

If it is found based on the determination, evaluation, or monitoring of the curve of the phase current in the direction of the first half-bridge that the change to a freewheel mode is possible, then the switching state can be maintained in the half-bridge with the two switching elements opened, for example. In the further course, the switching element that has been closed thus far can also be opened in the remaining half-bridges. In particular, the previously closed switching elements can be opened at times when the electrical current through the switching elements is at least approximately in the range of a zero pass.

Alternatively, it is also possible, after setting the freewheel in the first half-bridge and the subsequent determination of the curve of the phase current in the direction of the first half-bridge, to first close the previously opened switching element again and thus return to the complete active short-circuit. The previously detected curve of the electrical current during the period with the two switching elements opened in a half-bridge can then be evaluated in the control device 10 in order to check whether a change to the freewheel is possible. Such a processing of the previously detected current curve is particularly suitable when, for example, the control device 10 may only have a limited computing power, so that a quick evaluation of the current curve in real time is not possible. If, in this downstream evaluation of the current curve after the return to the active short circuit, it is found that a freewheel mode is possible, then the freewheel mode can then be set by opening all switching elements S1 to S6. Here, too, the previously closed switching elements S1 to S6 can preferably be opened at times when the electrical current through the respective switching elements is at least approximately in the range of a zero pass.

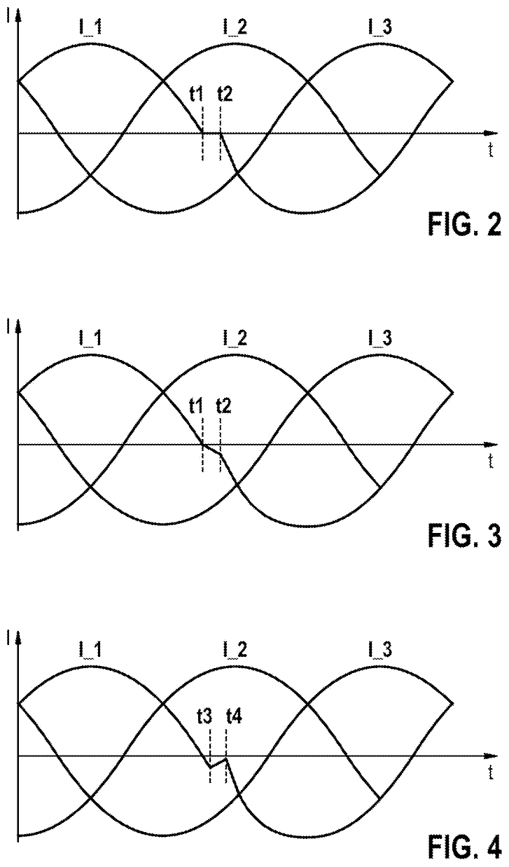

FIG. 2 shows a schematic representation of a current-time diagram for phase currents I_1, I_2, and I_3 in an electric drive system during a check of a possible change from the active short circuit to a freewheel mode. In this case, at the time t1 in the half-bridge for the current I_1, the switching element closed for the active short-circuit is opened precisely at the zero pass. At the time t2, this switching element is then closed again in order to return to the active short circuit. In the time period between t1 and t2, there is no electric current flowing in the corresponding phase. Thus, it can be assumed that, when switching to a freewheel, the electric voltage supplied by the electric machine 2 is sufficiently low so that no electric current will flow from the AC voltage terminal to the DC voltage terminal during the freewheel. Thus, a change from the active short circuit to the freewheel is possible.

FIG. 3 shows a further schematic representation of a current-time diagram for the phase currents I_1, I_2, and I_3 in an electric drive system during a check of a possible change from the active short circuit to a freewheel mode. Here, too, at the time t1 in the half-bridge for the current I_1 precisely at the zero pass, the switching element that was closed for the active short circuit is opened, and, at the time t2, this switching element is closed again in order to return to the active short circuit. By contrast to FIG. 2, during the time interval between t1 and t2, an electrical current flows in the phase with the half-bridge, in which both switching elements are opened. From this, it can be concluded that the electric voltage from the electric machine 2 is sufficiently high so that, in the case of a freewheel mode, an electric current would flow through the diodes arranged parallel to the switching elements S1 to S6.

FIG. 4 shows a further schematic illustration of a current-time diagram for phase currents I_1, I_2, and I_3 in an electric drive system during a check of a possible change from the active short circuit to a freewheel mode. In this case, the opening of the switching element in one of the half-bridges takes place at a time t3, which lies in the corresponding phase shortly after the zero pass of the current I_1. At the time t4, this switching element is closed again. Thus, already upon opening this switching element, a small electrical current flows in the corresponding phase. If this electric current I_1 tends to decrease in the further curve, this can be deemed an indication that a freewheel mode is possible. By contrast, if the electric current tends to increase more in this phase, then the active short circuit should be maintained.

Analogously, an evaluation is also possible when the switching element is opened at a time just before the zero pass. However, the current curve should be monitored over a period of time, which includes the (theoretical) zero pass in the current curve.

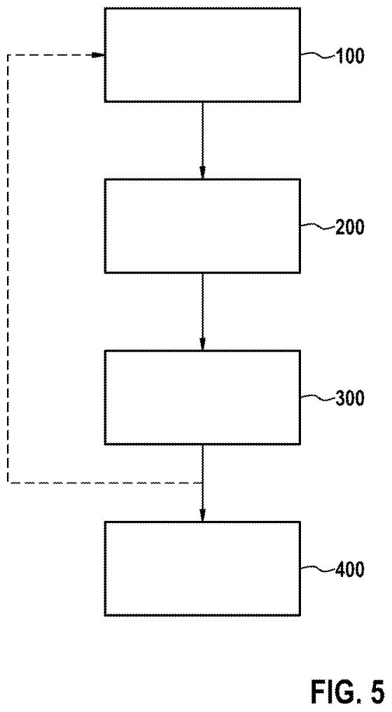

FIG. 5 shows a flowchart underlying a method for operating an inverter 1 for an electric drive system according to an embodiment. In principle, the method can comprise any of the steps already described above in connection with the control of the electric drive system. Analogously, the drive systems described above, in particular the inverter 1 as well as the control device 10 provided in the inverter 1, can also comprise any components required for the implementation of the method described below.

In step 100, an active short circuit is set in the inverter. In such an active short circuit, as already mentioned, either the upper switching elements S1, S3, and S5 are closed and the lower switching elements S2, S4, and S6 are opened, or alternatively, the lower switching elements S2, S4, and S6 are closed while the upper switching elements S1, S3, and S5 are opened.

In step 200, the previously closed switching element is opened in a first half-bridge of the inverter 1. In the remaining half-bridges of the inverter 1, the switching elements that are active will remain closed.

In step 300, the determination of an electrical parameter, which characterizes a curve of a phase current in the direction of the first half-bridge in which the two switching elements are opened, is carried out.

In step 400, the curve of the phase current in the direction of the first half-bridge is evaluated. If a predetermined condition for a change to the freewheel is satisfied, a freewheel mode is then set in the inverter 1. All switching elements S1 to S6 are opened in the half-bridges of the inverter. If, on the other hand, the specified change condition is not satisfied, then the inverter 1 is still operated in the active short-circuit.

The method of checking whether a change from an active short circuit to a freewheel mode is possible can generally be carried out at any one time during the operation of the inverter 1 in the active short circuit. For example, during operation in the active short-circuit, it can be checked regularly, in particular periodically at predetermined time intervals, whether a change from the active short-circuit to the freewheel mode may be possible. Furthermore, even if specified operating conditions are met, the check for a possible change to the freewheel mode may also occur. For example, a rotational speed of the electric machine 2 connected to the inverter 1 can be determined. In this case, for example, a change from the active short circuit to the freewheel mode can be contemplated only when the rotational speed of the electric machine 2 falls below a specified value. For example, at higher speeds, it can be assumed that in the phase coils of the electric machine 2, an electric voltage is induced that would result in a current flow in the inverter 1 from the AC voltage terminal to the DC voltage terminal.

Moreover, the change from the active short circuit to the freewheel mode can also of course be coupled to any desired further conditions. For example, it is also possible to only switch to a freewheel mode when additional operating conditions in the electric drive system, in particular the electric machine and/or the DC voltage source 3 connected to the DC voltage, in particular a traction battery, are satisfied.

In summary, the present invention relates to a change from an active short circuit to the freewheel in an inverter of an electric drive system. For this purpose, a switching state corresponding to the switching state of the freewheel is temporarily set in a half-bridge of the inverter. The current curve in this half-bridge is then evaluated in order to check whether a change to the freewheel is permissible or not.

1. A method for operating an inverter (1) for an electric drive system, wherein the inverter (1) comprises a plurality of half-bridges, each having two switching elements (S1-S6), and wherein the method comprises the following steps:
setting (100) an active short circuit in the inverter (1);
opening (200) the switching elements in a first half-bridge of the inverter (1);
determining (300) an electrical parameter that characterizes a curve of a phase current in the direction of the first half-bridge in which the two switching elements are opened;
setting (400) a freewheel mode in the inverter, in which all switching elements (S1-S6) of all half-bridges are opened if the curve of the phase current in the direction of the first half-bridge satisfies a predetermined change condition.

2. The method according to claim 1, wherein the active short circuit is switched to the freewheel mode if the amount of the phase current in the direction of the first half-bridge starting from a current zero pass does not exceed a specified threshold value.

3. The method according to claim 1, wherein the two switching elements in a half-bridge of the inverter are opened when a curve of the phase current in the direction of the first half-bridge is at least approximately in the range of a zero pass.

4. The method according to claim 1, wherein, in order to set (400) the freewheel mode in the inverter (1), the switching elements in the first half-bridge, in which both switching elements have previously been opened, remain open, and then the switching elements in the further half-bridges of the inverter (1) are opened.

5. The method according to claim 1, wherein, after determining (300) the electrical parameter, a switching element in the first half-bridge is first closed again to set an active short circuit; and
the curve of the phase current in the direction of the first half-bridge is then evaluated,
and, after the evaluation, a freewheel mode is set in the inverter (1) if the curve of the phase current in the direction of the first half-bridge satisfies the predetermined change condition.

6. The method according to claim 1, having a step for determining a rotational speed of an electric machine (2) connected to the inverter (1),
wherein the steps of opening (200) the two switching elements, subsequently determining (300) the electrical parameter, and setting (400) to the freewheel mode are only performed if the determined rotational speed of the electric machine (2) falls below a specified threshold value.

7. An inverter (1), having:
a plurality of half-bridges, each comprising two switching elements (S1-S6), wherein a diode is provided parallel to each switching element (S1-S6); and
a control device (10) designed so as to provide control signals for the switching elements (S1-S6) in the plurality of half-bridges;
wherein the control device (10) is designed to perform a method according claim 1.

8. An electric drive system, having:
an electric machine (2); and
an inverter (1) according to claim 7;
wherein the inverter (1) is connected to the electric machine (2) at an AC voltage terminal, and wherein the inverter (1) is designed to be connected to a DC voltage source at a DC voltage terminal.
